(19) United States
(12) Patent Application Publication
(10) Pub. No.: US 2023/0033104 A1
(43) Pub. Date: Feb. 2, 2023

(54) DETECTING USER ENGAGEMENT AND ADJUSTING SCHEDULED MEETINGS

(71) Applicant: Zoom Video Communications, Inc., San Jose, CA (US)

(72) Inventors: Graeme GEDDES, Aliso Viejo, CA (US); Shawn Michael Rolin, Saratoga, CA (US)

(73) Assignee: Zoom Video Communications, Inc., San Jose, CA (US)

(21) Appl. No.: 17/389,547

(22) Filed: Jul. 30, 2021

(51) Int. Cl. G06Q 10/10; H04L 29/06; G06N 20/00

(52) U.S. Cl. CPC G06Q 10/1095; H04L 65/403; G06N 20/00

(57) ABSTRACT

One example method includes accessing, by a calendar analysis software component executed by a video conference provider, a meeting calendar associated with a user; determining, using a first machine learning (“ML”) model by the calendar analysis software component, meeting scores for a plurality of meetings scheduled during a time period in the meeting calendar; generating, by the calendar analysis software component, a plurality of recommendations regarding adjusting a subset of the plurality of meetings in the meeting calendar; and providing, by the calendar analysis software component, indications corresponding to the plurality of recommendations to the user.

### CROSS-REFERENCE TO RELATED APPLICATIONS

This application is related to co-pending U.S. patent application Ser. No. ______, filed concurrently herewith, having Attorney Docket No. 107477-1245112, titled “Detecting User Engagement and Generating Join Recommendations.”

### FIELD

The present application generally relates to video conferencing, but more particularly relates to detecting user engagement and adjusting scheduled meetings.

### BACKGROUND

Videoconferencing has become a common way for people to meet as a group, but without being at the same physical location. Participants can be invited to a video conference meeting, join from their personal computers or telephones, and are able to see and hear each other, conversing largely as they would during an in-person group meeting or event. The advent of user-friendly video conferencing software has enabled teams to work collaboratively, despite being dispersed around the country or the world. It has also enabled families and friends to engage with each other in meaningful ways, despite being physically distant from each other.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1-3 show example systems for detecting user engagement and generating join recommendations;

FIG. 4 shows an example meeting analysis software component for detecting user engagement and generating join recommendations;

FIGS. 5A-5B show an example graphical user interface for a system for detecting user engagement and generating join recommendations;

FIG. 6 shows an example method for detecting user engagement and generating join recommendations; and

FIG. 7 shows an example computing device suitable for use with various systems and methods for detecting user engagement and generating join recommendations.

### DETAILED DESCRIPTION

Examples are described herein in the context of detecting user engagement and adjusting scheduled meetings. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Various examples are described for detecting user engagement and adjusting scheduled meetings. One example method includes accessing, by a calendar analysis software component executed by a video conference provider, a meeting calendar associated with a user; determining, using a first machine learning (“ML”) model by the calendar analysis software component, meeting scores for a plurality of meetings scheduled during a time period in the meeting calendar; generating, by the calendar analysis software component, a plurality of recommendations regarding adjusting a subset of the plurality of meetings in the meeting calendar; and providing, by the calendar analysis software component, indications corresponding to the plurality of recommendations to the user.

One example system includes a communications interface; a non-transitory computer-readable medium; and one or more processors communicatively coupled to the communications interface and the non-transitory computer-readable medium, the one or more processor configured to execute software executable instructions stored in the non-transitory computer-readable medium to access a meeting calendar associated with a user; determine, using a first machine learning (“ML”) model, meeting scores for a plurality of meetings scheduled during a time period in the meeting calendar; generate a plurality of recommendations regarding adjusting a subset of the plurality of meetings in the meeting calendar; and providing indications corresponding to the plurality of recommendations to the user.

One example non-transitory computer-readable medium comprising processor-executable instructions stored in the non-transitory computer-readable medium to cause one or more processors to access a meeting calendar associated with a user; determine, using a first machine learning (“ML”) model, meeting scores for a plurality of meetings scheduled during a time period in the meeting calendar; generate a plurality of recommendations regarding adjusting a subset of the plurality of meetings in the meeting calendar; and providing indications corresponding to the plurality of recommendations to the user.

As a part of their job, a person may have multiple different meetings scheduled over the course of days, weeks, and months; however, over time, attending large numbers of meetings can drain them mentally and physically. This can lead to people disengaging in important meetings or skipping those meetings entirely. To help prevent or mitigate these issues, a video conference provider may analyze a person's schedule to identify which meetings may be of greater or lesser importance and to proactively adjust the person's schedule, or recommend adjustments to the person's schedule, for the coming week. For example, it may take action, such as by declining one or more meeting invitations, proposing a rescheduled date and time or a reduced meeting time for one or more meetings, creating a template email for the user to decline one or more meetings, or deleting a link to a video conference in one or more meetings and only providing audio options.

A meeting's importance may vary depending from invitee to invitee a, depending on their role in the meeting, whether they frequently contribute in similar meetings, whether they tend to be disengaged in similar meetings, other meetings occurring during the same day, and other factors. For example, if a user frequently has meetings scheduled through a video conference provider, the video conference provider may be able to gather information about the user's attendance at the meetings, level of engagement during the meetings, etc.

In addition, because the video conference provider has access to video and audio from meetings held by video, the video conference provider can also capture metrics such as how often the participant speaks during similar meetings, whether they disable video during similar meetings, whether they are focused on different tasks during similar meetings, etc. Thus, the video conference provider may have access to some or all of a person's calendar as well as the substantive content from various meetings, and it may be able to determine which meetings are important to the person and which are less so.

To determine a particular meeting's importance, the video conference provider accesses a scheduled meeting for a person, such as one that is scheduled through the video conference provider. The video conference provider then identifies other similar meetings, such as if the meeting is a recurring meeting or based on similarities between meeting titles of past meetings, e.g., “weekly team meeting” or “weekly staff meeting.” After identifying similar meetings, the video conference provider accesses information gathered during those prior meetings. For example, the video conference provider may determine a level of engagement or participation in real-time or near-real-time during a meeting by passing audio or video through one or more analysis engines to determine whether the user is looking at their device's screen, e.g., using eye tracking, semantic analysis of things said or typed into a chat window by the person during the meeting, etc. as well as other metrics such as the amount of time spent talking, the amount of time that the person's audio feed is muted or their video feed is disabled, whether the video conferencing application is executing in the background or foreground, mouse movement, keyboard entry, etc.

In addition to the engagement information discussed above, the video conference provider may obtain other information about the meeting, such as the list of attendees and their respective roles, such as whether a supervisor or multiple supervisors for the person are in the meeting, whether the meeting has one or more clients attending, whether the meeting is a webinar or a conventional meeting, etc. Such information may provide additional indications of the importance of the meeting for the person.

The video conference provider then executes two trained machine learning (“ML”) models on the gathered information, one of which determines a value of the meeting, while the other determines a relative load imposed on the person by the meeting. A meeting's value may reflect an importance to the person, while the meeting's load may reflect the amount of effort imposed on the person, such as cognitive load based on participation. After receiving the outputs from the video conference provider can access other meetings scheduled on the same day and use a further ML model to determine whether the person should attend the meeting normally or in a way to reduce the impact on the person, such as by joining via audio only to allow the person to attend the meeting while engaging in some other activity, such as walking or driving. In some cases, the video conference provider may determine that the person should join by audio or skip the meeting entirely. For example, if a meeting has a low meeting value, but had a high load, e.g., because it is a long meeting, and the person has multiple other meetings scheduled for the day, the video conference provider may determine that the person should skip the meeting to enable them to be more engaged in other meetings scheduled during the day. Similarly, for meetings that are high value and low load, the video conference provider may suggest that the user attend the meeting in-person or by video.

The video conference provider may then perform this analysis for multiple or all meetings over a particular period of time, e.g., a week, bi-week, month, etc. and assess which meetings may be particularly important or may not be re-scheduled. It may then identify meetings which may be safely declined or attended using a lower-impact technology, such as by computer audio only or by telephone, which may allow the user a mental or physical break. The video conference provider may then determine loads or values for particular days, based on the meetings scheduled for the day or the adjoining days. For meetings identified for rescheduling, the video conference provider may propose re-scheduled times on days with low loads or values, e.g., days with large blocks of unscheduled time or with multiple low-load or low-value meetings, which may be attended by audio or skipped entirely.

In some examples the video conference provider may provide recommendations regarding adjusting the person's schedule, or may take autonomous action to adjust the schedule. To provide a recommendation to the person, the video conference provider may color-code a meeting in the user's calendar or it may send an email message or text message to the person with a text recommendation. The user may then elect to alter their schedule based on the recommended course of action. To take action autonomously, the video conference provider may decline one or more meetings or may proposed new scheduled dates, times, or durations for those meetings. In some examples, it may also highlight particularly important meetings, and may provide more robust reminders to the person so they know to be prepared or to ensure they do not miss the meeting particular.

This illustrative example is given to introduce the reader to the general subject matter discussed herein and the disclosure is not limited to this example. The following sections describe various additional non-limiting examples and examples of detecting user engagement and adjusting scheduled meetings.

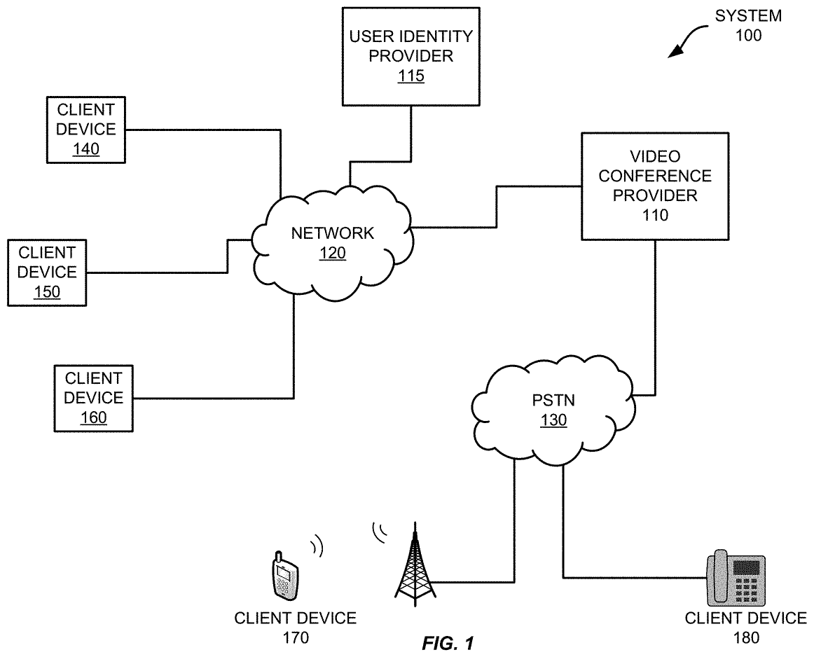

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the video conference provider 110. For example, the video conference provider 120 can be located within a private network to provide video conferencing services to devices within the private network, or it can be connected to a public network, e.g., the internet, so it may be accessed by anyone. Some examples may even provide a hybrid model in which a video conference provider 120 may supply components to enable a private organization to host private internal video conferences or to connect its system to the video conference provider 120 over a public network.

The system optionally also includes one or more user identity providers, e.g., user identity provider 115, which can provide user identity services to users of the client devices 140-160 and may authenticate user identities of one or more users to the video conference provider 110. In this example, the user identity provider 115 is operated by a different entity than the video conference provider 110, though in some examples, they may be the same entity.

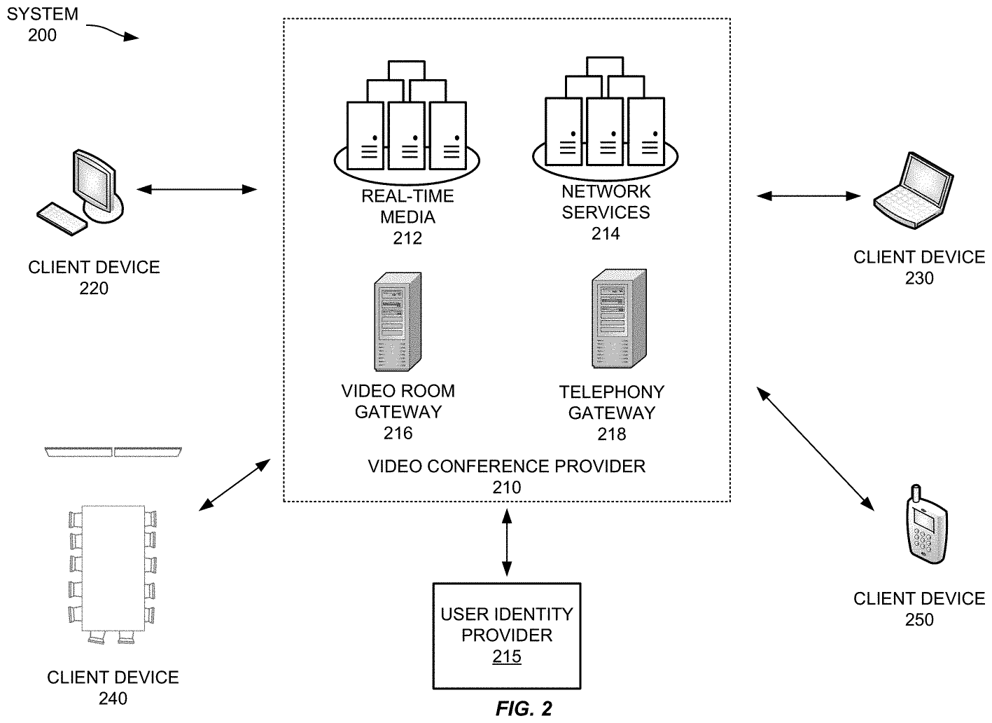

Video conference provider 110 allows clients to create videoconference meetings (or “meetings”) and invite others to participate in those meetings as well as perform other related functionality, such as recording the meetings, generating transcripts from meeting audio, manage user functionality in the meetings, enable text messaging during the meetings, create and manage breakout rooms from the main meeting, etc. FIG. 2, described below, provides a more detailed description of the architecture and functionality of the video conference provider 110.

Meetings in this example video conference provider 110 are provided in virtual “rooms” to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used. Further, in some examples, and as alluded to above, a meeting may also have “breakout” rooms. Such breakout rooms may also be rooms that are associated with a “main” videoconference room. Thus, participants in the main videoconference room may exit the room into a breakout room, e.g., to discuss a particular topic, before returning to the main room. The breakout rooms in this example are discrete meetings that are associated with the meeting in the main room. However, to join a breakout room, a participant must first enter the main room. A room may have any number of associated breakout rooms according to various examples.

To create a meeting with the video conference provider 110, a user may contact the video conference provider 110 using a client device 140-180 and select an option to create a new meeting. Such an option may be provided in a webpage accessed by a client device 140-160 or client application executed by a client device 140-160. For telephony devices, the user may be presented with an audio menu that they may navigate by pressing numeric buttons on their telephony device. To create the meeting, the video conference provider 110 may prompt the user for certain information, such as a date, time, and duration for the meeting, a number of participants, a type of encryption to use, whether the meeting is confidential or open to the public, etc. After receiving the various meeting settings, the video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating the that meeting has not yet started or the host may be required to specifically admit one or more of the users.

During the meeting, the participants may employ their client devices 140-180 to capture audio or video information and stream that information to the video conference provider 110. They also receive audio or video information from the video conference provider 210, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting and they will no longer receive audio or video streams for the meeting (and will stop transmitting audio or video streams). The video conference provider 110 may also invalidate the meeting information, such as the meeting identifier or password/passcode.

To provide such functionality, one or more client devices 140-180 may communicate with the video conference provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can make conventional telephone calls and is not limited solely to dedicated telephony devices like conventional telephones.

Referring again to client devices 140-160, these devices 140-160 contact the video conference provider 110 using network 120 and may provide information to the video conference provider 110 to access functionality provided by the video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the video conference provider 110.

A user identity provider 115 may be any entity trusted by the video conference provider 110 that can help identify a user to the video conference provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 110 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the video conference provider 110.

When the user accesses the video conference provider 110 using a client device, the video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the video conference provider 110 either provides or denies access to its services, respectively.

For telephony devices, e.g., client devices 170-180, the user may place a telephone call to the video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the video conference provider 110. For example, telephony devices may be unable to provide user identification information to identify the telephony device or the user to the video conference provider 110. Thus, the video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the video conference provider 110, even in cases where the user has an authenticated identity and employs a client device capable of identifying the user to the video conference provider 110. The video conference provider 110 may determine whether to allow such anonymous users to use services provided by the video conference provider 110. Anonymous users, regardless of the reason for anonymity, may be restricted as discussed above with respect to users employing telephony devices, and in some cases may be prevented from accessing certain meetings or other services, or may be entirely prevented from accessing the video conference provider 110.

Referring again to video conference provider 110, in some examples, it may allow client devices 140-160 to encrypt their respective video and audio streams to help improve privacy in their meetings. Encryption may be provided between the client devices 140-160 and the video conference provider 110 or it may be provided in an end-to-end configuration where multimedia streams transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the video conference provider 110, while allowing the video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the video conference provider 110. Further, such a system enables users to use a wide variety of different client devices 140-180 from traditional standards-based video conferencing hardware to dedicated video conferencing equipment to laptop or desktop computers to handheld devices to legacy telephony devices, etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the video conference provider 210 over a communications network, such as the internet for client devices 220-240 or the PSTN for client device 250, generally as described above with respect to FIG. 1. The video conference provider 210 is also in communication with one or more user identity providers 215, which can authenticate various users to the video conference provider 210 generally as described above with respect to FIG. 1.

In this example, the video conference provider 210 employs multiple different servers (or groups of servers) to provide different aspects of video conference functionality, thereby enabling the various client devices to create and participate in video conference meetings. The video conference provider 210 uses one or more real-time media servers 212, one or more network services servers 214, one or more video room gateways 216, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed streams to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the video conference system 210. In some such examples, the real-time media servers 212 may decrypt incoming multimedia streams, multiplex the multimedia streams appropriately for the various clients, and encrypt the multiplexed streams for transmission.

In some examples, to provide multiplexed streams, the video conference provider 210 may receive multimedia streams from the various participants and publish those streams to the various participants to subscribe to and receive. Thus, the video conference provider 210 notifies a client device, e.g., client device 220, about various multimedia streams available from the other client devices 230-250, and the client device 220 can select which multimedia stream(s) to subscribe to and receive. In some examples, the video conference provider 210 may provide to each client device the available streams from the other client devices, but from the respective client device itself, though in other examples it may provide all available streams to all available client devices. Using such a multiplexing technique, the video conference provider 210 may enable multiple different streams of varying quality, thereby allowing client devices to change streams in real-time as needed, e.g., based on network bandwidth, latency, etc.

As mentioned above with respect to FIG. 1, the video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the video conference provider 210 may allow a meeting participant to notify it of inappropriate behavior or content in a meeting. Such a notification may trigger the real-time media servers to 212 record a portion of the meeting for review by the video conference provider 210. Still other functionality may be implemented to take actions based on the decrypted multimedia streams at the video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the video conference provider under a supervisory set of servers. When a client device 220-250 accesses the video conference provider 210, it will typically communicate with one or more network services servers 214 to access their account or to participate in a meeting.

When a client device 220-250 first contacts the video conference provider 210 in this example, it is routed to a network services server 214. The client device may then provide access credentials for a user, e.g., a username and password or single sign-on credentials, to gain authenticated access to the video conference provider 210. This process may involve the network services servers 214 contacting a user identity provider 215 to verify the provided credentials. Once the user's credentials have been accepted, the client device 214 may perform administrative functionality, like updating user account information, if the user has an identity with the video conference provider 210, or scheduling a new meeting, by interacting with the network services servers 214.

In some examples, users may access the video conference provider 210 anonymously. When communicating anonymously, a client device 220-250 may communicate with one or more network services servers 214 but only provide information to create or join a meeting, depending on what features the video conference provider allows for anonymous users. For example, an anonymous user may access the video conference provider using client 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, creating sub-meetings or “break-out” rooms, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to create a break-out room for one or more meeting participants to join, such a command may also be handled by a network services server 214, which may create a new meeting record corresponding to the break-out room and then connect one or more meeting participants to the break-out room similarly to how it originally admitted the participants to the meeting itself.

In addition to creating and administering on-going meetings, the network services server(s) 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the video conference provider 210. For example, the video conferencing hardware may be provided by the video conference provider to one or more of its subscribers, which may provide access credentials to the video conferencing hardware to use to connect to the video conference provider 210.

The video room gateway servers 216 provide specialized authentication and communication with the dedicated video conferencing hardware that may not be available to other client devices 220-230, 250. For example, the video conferencing hardware may register with the video conference provider 210 when it is first installed and the video room gateway servers 216 may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the video conference provider 210.

Referring now to the telephony gateway servers 218, these servers 218 enable and facilitate telephony devices' participation in meetings hosed by the video conference provider 210. Because telephony devices communicate using the PSTN and not using computer networking protocols, such as TCP/IP, the telephony gateway servers 218 act as an interface that converts between the PSTN and the networking system used by the video conference provider 210.

For example, if a user uses a telephony device to connect to a meeting, they may dial a phone number corresponding to one of the video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio signals to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server 218 is instead joined to the meeting on the telephony device's behalf.

After joining the meeting, the telephony gateway server 218 receives an audio stream from the telephony device and provides it to the corresponding real-time media server 212, and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

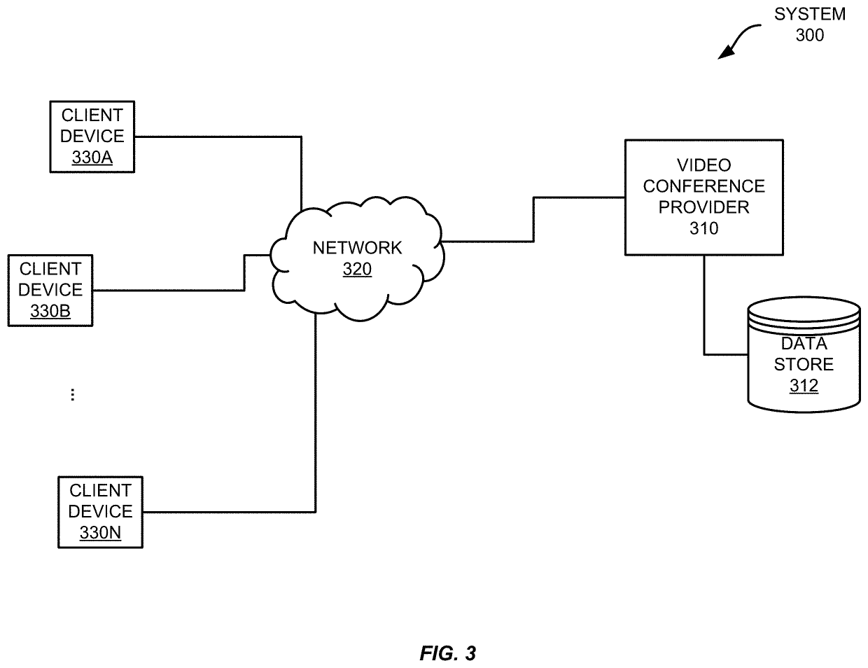

Referring now to FIG. 3, FIG. 3 shows an example system for detecting user engagement and adjusting scheduled meetings. In this example, a video conference provider 310 and multiple client devices 330a-n are connected to network 320. Users using a respective client device 330a-n may maintain electronic calendars that include various scheduled meetings, some of which may be scheduled via the video conference provider 310. Thus, the video conference provider 310 may have access to some or all meetings for a particular user, which may be stored in the data store 312.

For example, when a host schedules a new video conference, they may access the video conference provider 310 to configure the meeting and to obtain certain information, such as a meeting identifier and password, generally as described above with respect to FIGS. 1 and 2. In addition, the host may provide an invitee list when sending an invitation to the meeting. The video conference provider may thus obtain information about the schedules for each of the meeting invitees. In other examples, various users may provide access to their electronic calendar to the video conference provider, which may allow hosts to more easily schedule meetings by providing information about the users' availability. Thus, the video conference provider 310 may obtain and store calendar information for one or more users associated with the client devices 330a-n.

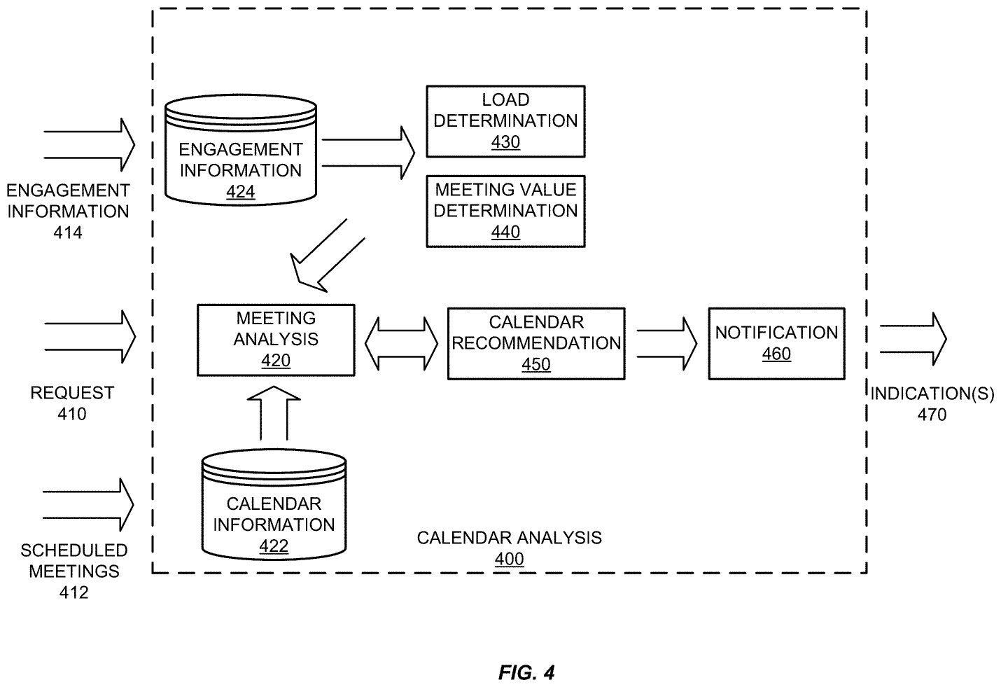

After obtaining calendar information for one or more users, it may attempt to determine characteristics of one or more meetings and determine meeting scores for the meetings, which will be discussed in greater detail with respect to FIG. 4. In this example, the video conference provider 310 may analyze meetings in response to requests issued from a user's client device, e.g., client device 330a. For example, a user of the client device 330a may access their electronic calendar and select a particular week (or other duration) to be analyzed. In some examples, the user may ask that the duration be re-analyzed when a new meeting invitation is received, but before the user has accepted or declined the invitation. In still further examples, the user may request that the video conference provider analyze all meetings for a particular week, bi-week (a two-week period), month, etc. or establish a routine process by which a user's meetings are analyzed for a particular duration, such as at the end of the preceding week. Such systems may allow the user to evaluate their schedule for the next week (or other duration) to help them plan their week and better understand their schedule.

After the video conference provider 310 has identified a duration to analyze, it identifies one or more scheduled meetings and analyzes each meeting. In this example it first determines one or more characteristics of the meeting. A meeting's characteristics can include a wide variety of characteristics. For example, it can include timing information such as the date, time, or duration of the meeting. It can also determine characteristics based on other invitees to the meeting, such as the number of invitees, reporting levels of other invitees within an organization, titles or positions held by other invitees to the meeting, organizations the other invitees of the meeting are associated with, etc. It may also determine whether one or more documents were attached to the meeting invitation or whether an agenda was attached or included in the invitation, and if so, whether the user's name appears on the agenda.

In some examples, the video conference provider 310 may determine whether the meeting is similar to other past meetings. For example, the video conference provider 310 may determine that a scheduled meeting is a recurring meeting that has occurred one or more times in the past, such as based on a meeting invitation including an option to recur at particular dates or times. Alternatively, it may determine that a meeting is similar to past meetings based on having similar or identical invitee lists, the title of the meeting being the same or similar to other past meetings, etc.

If the video conference provider 310 determines that a meeting is the same or similar to a past meeting, it may obtain information captured or determined from one or more of those past meetings from the data store 312. For example, during video conferences, the video conference provider 310 may detect or monitor certain aspects of user engagement during the meeting, such as by using eye gaze detection to determine whether the user is watching the video conference or is engaged in another activity. It may also measure an amount of time the user spends speaking or presenting during past similar meetings, how often or for how long a user disables their video or audio feed, whether the video conference is in the foreground of the user's display or is in the background due to another application being used, whether the video conference is minimized and for how long, if the user reduces the output level of or mutes their audio output devices, etc. Such information may be measured and stored in the data store 312 and accessed by the video conference provider 310 to analyze the meeting.

Based on such information, the video conference provider may determine a potential value of the meeting to the user or it may determine a potential load on the user to attend the meeting. The meeting's value may indicate how important it may be to the user to attend the meeting. For example, a one-on-one meeting with the user's supervisor may have a high value, while a monthly staff breakfast meeting may have a low value. A meeting's load may indicate the impact on the user, such as mentally or physically. A two-hour meeting where the user's name appears multiple times on the agenda may impose a significant load on the user, while a 30-minute routine staff meeting may impose a low load. Thus, the video conference provider may attempt to determine either or both of a value or a load for the meeting.

Other characteristics related to may be determined in some examples as well. For example, the video conference provider 310 may also analyze the entire identified duration to determine an importance of a particular meeting. For example, the video conference provider 310 may attempt to determine a load imposed on the user by their meeting schedule as well as the load imposed on the user by the specific meeting. Thus, if the user has only one meeting scheduled for the day, the video conference provider 310 may determine the load for the meeting based solely on characteristics of the meeting itself. However, if multiple meetings occur on the same day, the video conference provider 310 conference provider may determine the amount of time the user is scheduled to be in meetings on a particular day, how much of a break the user's schedule has prior to the meeting, loads or values of other meetings during the day, etc. Such characteristics associated with other meetings during the day, or even during the week or over a longer period, may be determined and used to determine a meeting's importance and ultimately provide a recommendation to the user about the meeting.

After determining characteristics associated with the meeting, the video conference provider 310 generates a recommendation to the user regarding whether to attend or skip the meeting, and if the user is going to attend the meeting, a recommendation as to how to attend the meeting, e.g., in-person, by video conference, or by audio only. It may also provide other recommendations, such as to reschedule the meeting for a different day or time, or to reduce the duration of the meeting, e.g., from sixty minutes to thirty. The recommendation can then be provided to the user by color-coding the meeting on the user's electronic calendar, providing a textual recommendation to the user, such as by email or text message, etc. In some examples, the video conference provider may provide additional information along with the recommendation, such as a dial-in number if the video conference provider 310 recommends the user only join by audio, or an option to confirm the user approves a “decline” response be sent to the meeting organizer In some examples, the video conference provider 310 may take action without input from the user, such as to decline attending a meeting on the user's behalf. Thus, the video conference provider 310 is able to assess a particular meeting and by applying such techniques to some or all of the meetings during the duration, the video conference provider 310 may be able to assess the various meetings and determine recommendations or actions to take to reduce the impact of the user's schedule on the user and to potentially improve the user's productivity and cognitive health, while ensuring the user stays engaged with important aspects of their professional life.

After obtaining assessments of each meeting within the identified duration, the video conference provider 310 may identify one or more meetings to take action on, which is described in more detail with respect to FIG. 4. For example, the video conference provider may identify a day, a portion of a day, or a multi-day period that imposes a significant load on the user or includes multiple low-value meetings while occupying a significant portion of a work schedule. The video conference provider 310 may then select one or more of the meetings based on their respective loads or values and recommend action to the user, or take autonomous action, to help alleviate the burden on the user. For example, if a two-day period includes multiple hour-long meetings, e.g., a moderate to high physical or cognitive load accruing over that time period, with low value, e.g., due to low historic user engagement, the video conference provider 310 may generate recommendations to decline or skip one or more of the meetings, or it may recommend attending one or more by audio or by phone. Attending by audio-only may allow the user to take the call while out for a walk or to engage in other activity, such as exercising, working on other tasks, etc., while also attending the meeting.

Referring now to FIG. 4, FIG. 4 shows an example calendar analysis software component 400 of a video conference provider, e.g., video conference provider 310, for detecting user engagement and adjusting scheduled meetings. The calendar analysis software component 400 shown in FIG. 4 receives scheduled meeting information, such as from a user's electronic calendar, and stores it in a calendar information data store 422. Subsequently, the calendar analysis software component 400 receives a request 410 to generate recommendations for meetings scheduled during a predetermined duration. In response to the request, a meeting analysis component 420 accesses the calendar information data store 422 to obtain information about meetings scheduled during that duration. In addition, a load determination component 430 and a meeting value determination component 440 access a meeting information data store 422 to obtain information related to those scheduled meetings.

The meeting analysis component 420 receives, for each scheduled meeting, meeting load information and meeting value information from the meeting load and meeting value determination components 430, 440, in addition to meeting information received from the calendar information data store 422. It then generates meeting information for the meetings during the identified duration, which it provides to the calendar recommendation component 450. The calendar recommendation component 450 receives the meeting information and determines actions to take or recommendations to provide based on the meeting information, which are then provided to notification component 460, which generates and outputs one or more indications 470 corresponding to meetings during the identified duration.

The calendar information data store 422 maintains one or more data records corresponding to scheduled meetings received from various users' client devices, which may be received as one or more scheduled meetings 412. The scheduled meetings 412 may be maintained in the respective users' electronic calendars and information about those scheduled meetings may be transmitted to the calendar information data store 422, or one or more users may directly schedule meetings via a video conference provider, which may store the scheduled meetings in the calendar information data store 422. Further, some users may schedule meetings through a variety of different electronic calendars, some or all of which may provide scheduled meeting information to the video conference provider 310, either automatically or at the request of the respective user.

The engagement information data store 424, in contrast, stores engagement information 414 for various users obtained during past meetings. For example, a user employs video conference software to join and interact during a meeting, such as by video and audio. As the user interacts during a meeting, the video conference software may capture or determine information about the user's engagement with the meeting, such as by performing gaze detection to determine if the user is looking at the video conference or in another direction (e.g., at another device), or by capturing audio and determining whether the user is speaking during the meeting and, in some examples, what the user is saying, e.g., by employing semantic analysis. Other information gathered may include whether the user disabled audio or video inputs during the meeting and for how long, whether the user was interacting with other software applications during the meeting (e.g., based on whether the video conference software is in the foreground or background or minimized), whether other users audio streams are identifying or addressing the user, whether the user is engaging in text messaging and, if so, whether the text messaging relates to the meeting or is unrelated, etc. Some examples may capture sentiment information during a meeting, such as determining whether the user is paying attention or is distracted, whether their facial expression indicates interest or attention, etc.

Such engagement information 414 is then reported to the video conference provider 310, which stores it in the engagement information data store 424 and associates it with the user and with the meeting. At a later time, the calendar analysis software component 400 may obtain engagement information from the engagement information data store 424 as will be described in more detail below with respect to the load and meeting value determination components 430, 440.

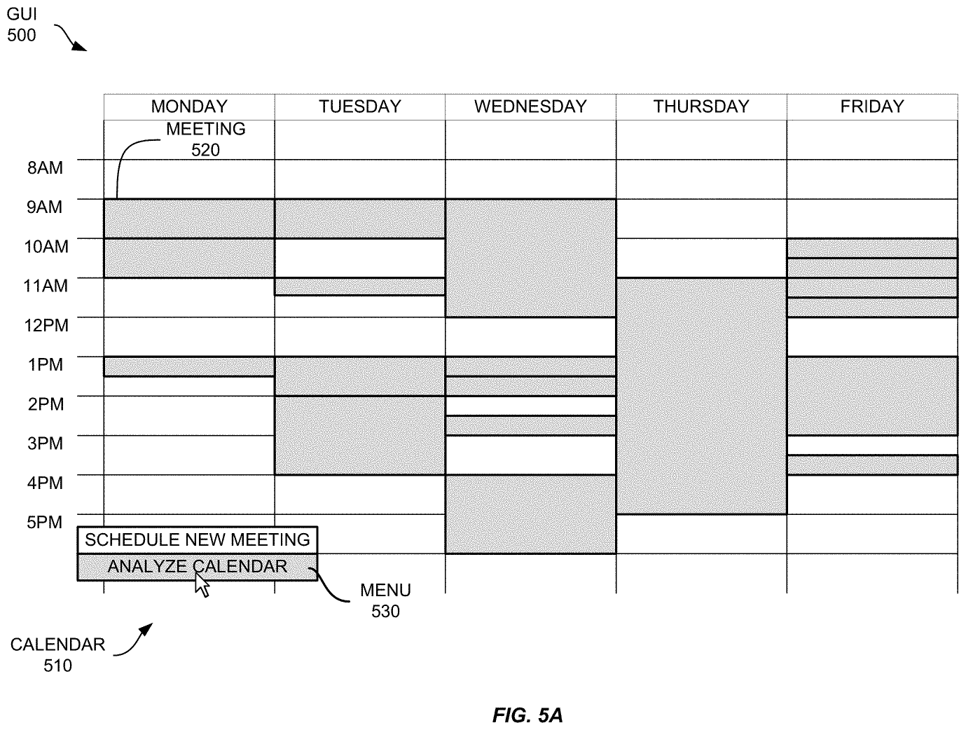

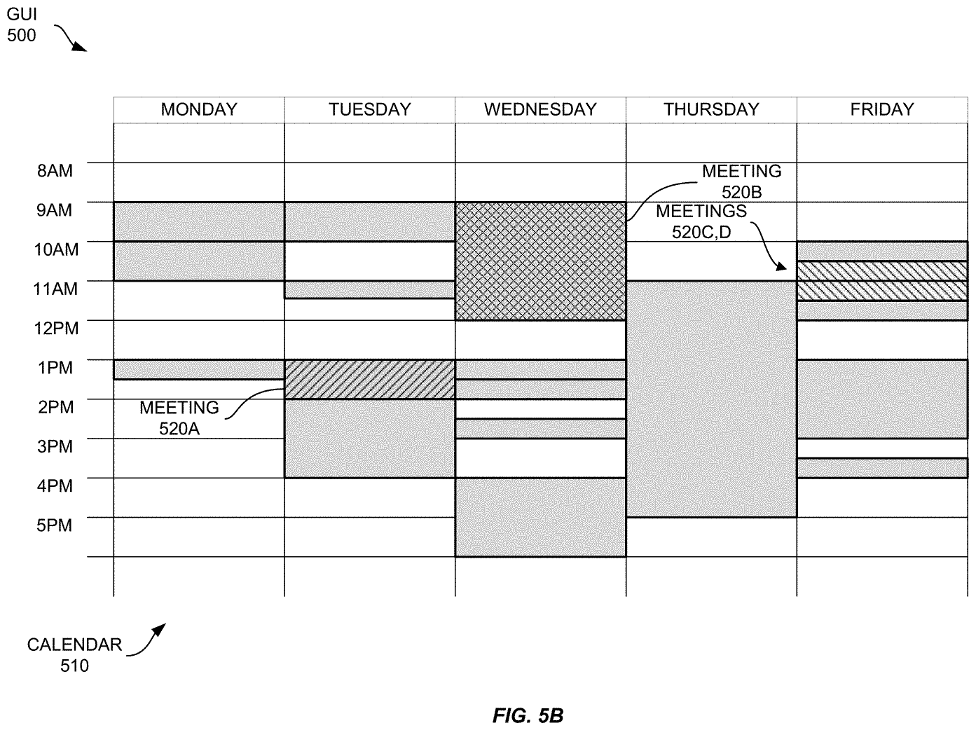

A request 410 to analyze a user's calendar over a particular duration may be received from a user, such as from their client device, or it may be generated autonomously by the user's client device or another computing device, such as the user's electronic calendar. In some examples, the video conference provider 310 itself may initiate the request with or without input from the corresponding user. The request in this example identifies the user and provides a time period over which to perform the analysis. For example, FIG. 5A illustrates an example graphical user interface (“GUI”) 500 including a graphical representation of the user's calendar 510 for a particular time period, e.g., a week. Meetings are identified by shaded boxes with sizes corresponding to a scheduled meeting time. The user has right-clicked while hovering a cursor over the calendar and has been presented with a menu 530. The user has selected the “Analyze Calendar” option to send a request for a recommendation for the meeting.

When the video conference provider 310 receives a request 410 to analyze a calendar over a time period (or duration) for a user, it employs calendar analysis software component 400 to analyze meetings within the duration. To perform the analysis, the calendar analysis software component 420 employs the meeting analysis component 420 and the calendar recommendation component 450, and may also employ one or more of the load determination component 430 and the meeting value determination component 440. The meeting analysis component 420 includes a trained machine learning (“ML”) model that accepts meeting characteristics, meeting load information, meeting value information, etc. and generates corresponding meeting information.

In this example, the meeting analysis component 420 receives load information and meeting value information from the load determination and meeting value determination components 430, 440, which are discussed in more detail below. It also determines characteristics of the meetings, such as the dates and times of the meetings, the durations of the meetings, the user's role in each meeting (e.g., host, organizer, presenter, participant, etc.), other attendees in each meeting, the roles of the other attendees, etc. In addition, to analyze a particular meeting, the meeting analysis component 420 may access other scheduled meetings stored in the calendar information data store 422 that the user has scheduled on the same day. It may also request meeting load information or meeting value information (or both) from the load determination and meeting value determination components 430, 440 for such meetings.

The meeting load determination component 430 uses a trained ML model to determine a load a meeting will likely impose on the user. A load may be a cognitive load, which may be imposed because the user must be actively engaged during the meeting, e.g., the user is the meeting host, a presenter, a moderator, etc. In meetings where the user is unlikely to be significantly engaged, a meeting load may be small. Similarly, a meeting may impose a physical load on the user, such as due to requiring the user to be awake or in a meeting at an abnormal time, or to attending long meetings (e.g., longer than thirty or sixty minutes), and even whether the user will likely be actively participating in the meeting, etc. Some loads may involve both mental and physical loads, for example if the meeting will be the fourth consecutive hour-long meeting, or the meeting will extend the workday by an hour or more.

To provide input to the trained ML model, the load determination component 424 accesses the engagement information data store 424 to identify past meetings that are similar to a meeting to be analyzed. Past similar meetings may be identified based on the identified meeting as being an instance of a recurring meeting. In some examples, the load determination component 424 may identify past meetings including the same set of participants, the same title or a similar title, the same duration, the same host or organizer, etc. For example, if the meeting being analyzed is titled “weekly development team meeting,” the load determination component 424 may identify past meetings that include “team meeting” or similar phrases in the subject line and that lasted for a similar amount of time. Some examples may employ a second trained ML model to identify similar meetings, such as based on characteristics of the meeting, such as the characteristics discussed above, as well as data gathered during the meeting.

As discussed above, the engagement information data store 424 stores information gathered from various participants during past meetings. The information may be based on eye-tracking or gaze detection performed on a participant's video feed, detected speaking coming from the participant's video feed, data indicating time spent with video or audio disabled versus enabled, whether the video conference application is in the background or minimized during the meeting and for how long, etc. Some examples may employ semantic analysis of audio streams during the meeting to determine whether the participant is being asked questions, whether the participant is asking questions, whether the participant is being assigned action items, etc.

After obtaining such engagement information from similar meetings, the load determination component 424 provides some or all of it to the trained ML model to obtain a likely meeting load. Any suitable ML model may be used according to different examples, such as deep convolutional neural networks (“CNNs”); a residual neural network (“Resnet”), or a recurrent neural network, e.g. long short-term memory (“LSTM”) models or gated recurrent units (“GRUs”) models, a three-dimensional CNN (“3DCNN”), a dynamic time warping (“DTW”) technique, a hidden Markov model (“HMM”), etc., or combinations of one or more of such techniques—e.g., CNN-HMM or MCNN (Multi-Scale Convolutional Neural Network). Further, some examples may employ adversarial networks, such as generative adversarial networks (“GANs”), or may employ autoencoders (“AEs”) in conjunction with ML models, such as AEGANs or variational AEGANs (“VAEGANs”).

The trained ML model outputs a likely meeting load for the meeting. In some examples, the trained ML model may output multiple values indicating probabilities of different loads, e.g., low, medium, and high. The load determination component 424 may select the load having the highest corresponding probability. Further, in some examples, the trained ML model may output indications of two different types of loads: mental and physical. The determined load(s) may be supplied in load information sent to the meeting analysis component 420.

In addition to using the load determination component 430, the calendar analysis software component 400 also executes a meeting value determination component 440. Similar to the load determination component 430, the meeting value determination component 440 employs a trained ML model to determine a likely value of the meeting to the user. The value of a meeting relates to the benefit the user will accrue from attending the meeting. For example, a one-on-one meeting with the user's supervisor or one of the user's clients likely has a high value, whereas a webinar presentation relating to a different portion of the business than the user is involved with may have a low value.

The meeting value component 440 accesses the engagement information data store 424 to identify similar meetings to the meeting being analyzed, generally as discussed above with respect to the meeting load component 430. Alternatively, a separate software component may identify similar meetings to the identified meeting and supply such information to both the load determination and meeting value determination components 430, 440. After identifying similar meetings, the meeting value determination component 440 determines values of meetings similar to the identified meeting. The meeting values may have been previously provided by the user, e.g., following a meeting, the user may be asked the relative value of the meeting on a numeric scale, and subsequently stored in the engagement information data store 424 and associated with the meeting. In some examples, the meeting value determination component 440 may identify a number of participants and the participants' levels in a corporate reporting structure, e.g., president, vice president, supervisor, etc. Similarly, it may analyze email addresses or other user identifiers to determine organizations or companies each meeting invitee is associated with and determine a relationship with the user, such as whether one or more meeting invitees is a client, a vendor, a partner, etc. Further, the user's role in the identified meeting may also be determined, e.g., whether the user is the host or organizer, whether user is identified on a meeting agenda has presenting content, etc. Still other meeting characteristics may be determined according to different examples.

In addition to such meeting characteristics, the meeting value determination component 440 may also access engagement information, such as discussed above with respect to the load determination component 430. For example, information about the user's engagement with similar meetings may indicate the value of the identified meeting, such as how often and for how long the user speaks during the meeting; whether the user's attention remains on the meeting or is diverted to other tasks, e.g., based on whether the user enables or disables their audio or video feeds or whether the user brings one or more other applications into the foreground and minimizes the video conference software or moves it to the background.

Such information may then be provided to the trained ML model, which determines a likely meeting value for the meeting. In this example, the trained ML model outputs a set (or tuple) of probabilities corresponding to possible meeting values, e.g., low, medium or high, or numeric values, e.g., between 0 and 10. The meeting value determination component 440 may then select one of the meeting values as the meeting value for the meeting, e.g., by selecting the meeting value with the highest likelihood. The meeting value determination component 440 then provides the meeting value as a part of meeting information to the meeting analysis component 420.

After determining characteristics of the meeting, as discussed above, and receiving the meeting load and meeting value information, the meeting analysis component 420 determines a score corresponding to the meeting. In some examples, the meeting analysis component 420 may generate a score for the meeting based on the characteristics, the load information, and the meeting value information. For example, it may generate a score by summing values corresponding to the load information and the meeting value information and multiplying the sum based on a meeting length. In some examples, a meeting value may be directly proportional to a meeting score, indicating that high value meetings lead to a high meeting score, while a load may be indirectly proportional to meeting score, indicating that high-load meetings may lead to a low meeting score. Further, such proportions may be affected by other scheduled meetings during the day. For example, if the meeting is the third consecutive meeting, a multiplier based on the amount of time spent in meetings prior to the identified meeting may be applied to the load. In other examples, it may employ a trained ML model to determine a score for the meeting based on determined calendar information and the received load and meeting value information. The trained ML model may then output a score for the meeting. In some examples, the trained ML model may output a tuple having multiple different scores and associated determined probabilities for each score.

After determining a score for the meeting, the meeting analysis component 420 provides the score to the calendar recommendation component 450 as meeting information. In some examples, it may also provide load or value information received from the meeting load or meeting value component(s) 430, 440. Further in some examples, the meeting analysis component 420 may also provide the one or more identified characteristics of the meeting. Thus, for each meeting analyzed for a user during the identified duration, the meeting analysis component 420 supplies meeting information, which is received and used by the calendar recommendation component 450. The meeting analysis component 420 may also provide an indication once all meetings within the duration have been analyzed, which may cause the calendar recommendation component 450 to analyze the meeting information to determine one or more recommendations or actions to take with respect to the user's schedule.

The calendar recommendation component 450 receives the meeting information, analyzes the user's calendar for the duration based on the meeting information, and generates one or more recommendations or actions to be taken. In this example, the calendar recommendation component 450 may employ a multidimensional optimization algorithm to assess the meetings and determine changes to the calendar that may reduce a load on the user on one or more days during the time period, while maintaining high-value meetings, which may enable the user to be better engaged with such meetings, while still attending some or all the lower-value meetings on their schedule.

The calendar recommendation component 450 receives the meeting information from the meeting analysis component 420 and attempts to optimize the calendar to reduce a load on the user over the identified duration. Optimization in this sense relates to reducing the load on the user imposed by the scheduled meetings, while maintaining a similar level of meeting value. In some examples, optimization may also include avoiding declining or skipping scheduled meetings.

To determine one or more recommendations to the user the calendar recommendation component 450 may make hypothetical changes to the user's schedule during the identified duration and assess resulting changes to the load on the user or value to the user. Hypothetical changes may be made based on meeting scores determined by the meeting analysis component 420. For example, the calendar recommendation component 450 may hypothetically implement one or more of the recommendations and determine an impact on the user's schedule. Each proposed schedule, including the original schedule, may be scored based on the meeting information.

To adjust the schedule, the calendar recommendation component 450 may identify one or more meetings having low scores, which may indicate a high load or low value (or both), and take a hypothetical action on it, such as to hypothetically decline the meeting, hypothetically attend the meeting by phone, or hypothetically re-schedule the meeting to a different time during the time period. The calendar recommendation component 450 may determine updated meeting scores for each meeting in the hypothetical schedule and determine a score for the schedule. As the calendar recommendation component 450 iterates through different adjustments to the schedule, it accumulates scores for each calendar schedule during the time period. It may iterate through all possible variations on the calendar or it may only analyze variations based on adjusting meetings with a score below a threshold or a value below a threshold. Still other examples may use other techniques to reduce a search space for the technique. After assessing the various hypothetical schedules, it may identify one or more schedules having better scores than the user's existing schedule. It may provide these identified schedules to the notification component 460 as schedule information.

The notification component 460 determines a notification to provide and outputs an indication to cause the notification to be provided to the participant. In this example, the notification component determines a notification should be output to the user's calendar based on user-selected notification settings, such as to color code meetings based on whether they should remain unchanged, declined or skipped, attended by audio only, rescheduled, etc. Other types of notifications may include text messages, emails, on-screen pop-up notifications, etc., that identify proposed changes to the user's calendar, including dates and times for meetings that are proposed to be rescheduled. In some examples, the notification component 460 may generate one or more messages to cause changes to be made to the user's schedule, such as by sending meeting decline messages or proposing new times for a scheduled meeting.

The notification component 460 then, based on the determined notification, outputs an indication of the recommendation. In this example, the indication causes the appearance of the participant's calendar to change as shown in FIG. 5B. In this example, meeting 520a has been marked with right-leaning hash marks, indicating the user should attend the meeting by audio only. Meeting 520b has been marked with cross-hatches to indicate that the user should decline the meeting or skip it. Finally, meetings 520c-d have been marked with left-leaning hash marks, indicating the user should reschedule these meetings. And while patterns have been used in this example, different colors may be applied to the calendar according to different examples. For example, red coloring may indicate that the user may skip the meeting, while a green coloring may indicate that the user should attend the meeting in-person and a yellow coloring indicating the user may attend by audio or video. However, other color schemes or techniques may be employed according to different examples. Further, other indications may be provided, such as a colored or patterned outline around the meeting in the electronic calendar, a flag or other graphic or animation may be associated with the displayed meeting in the electronic calendar. In some examples, the indication may include an audible notification, such as a chime or a spoken message of the recommendation. In some examples, the notification may include a haptic output, such as a vibration.

In addition to providing indications of recommendations to the user, such as those discussed above, the notification component 460 may also cause one or more actions to be taken. For example, if the calendar recommendation component 450 provides schedule information a new time for one or more meetings that should be rescheduled, the notification component 460 may generate communications to the meeting host for the respective meetings to be rescheduled and requesting it be rescheduled for the identified date and time, or with a reduced duration. Further, if the user is the host of a meeting, the notification component 460 may generate a revised meeting invitation based on the received schedule information, which may include a new date and time for the meeting.

For meetings that the calendar recommendation component 450 has proposed skipping or declining, the notification component 460 may generate and transmit a communication to the host of the meeting declining the meeting invitation. In some examples, the notification component 460 may delete the meeting from the user's calendar, with or without sending a corresponding notification to the meeting host. Further, if a meeting is declined or deleted, the notification component 460 may provide an indicator in the user's calendar indicating that a previously scheduled meeting for a corresponding time-slot has been cancelled. Thus, the user may be able to determine that the meeting has been automatically declined, rather than the meeting simply disappearing from the user's calendar, potentially without their realization.

In some examples, the notification component 460 may alter a scheduled meeting in the user's calendar without canceling it. For example, if the calendar recommendation component 450 recommends attending a meeting in a particular manner, e.g., by audio only, by video, or in-person, the notification component may insert information into the schedule meeting on the user's calendar, such as to delete certain information, e.g., a video conference link, to help cause the user to only attend by dial-in, or may instead (or also) insert the dial-in information into a “location” field for the meeting in the calendar. Or in some examples, it may include (or send a request for and then include) a video conference link in the “location field”, but delete reference to a physical conference room if the recommendation is to attend by video. Similarly, if the recommended action is to join in-person, an identification of a physical conference room may be added to a “location” field for the meeting in the user's calendar. Thus, the notification component 460 can autonomously alter the user's calendar in a variety of ways to implement the recommendations from the calendar recommendation component 450.

The functionality discussed above performed by the calendar analysis software component 400 are described as being performed by specific components; however, it should be appreciated that the functionality may be implemented in any suitable set of components or as a single component. It should be appreciated that no specific functional breakdown within the calendar analysis software component 400 is required.

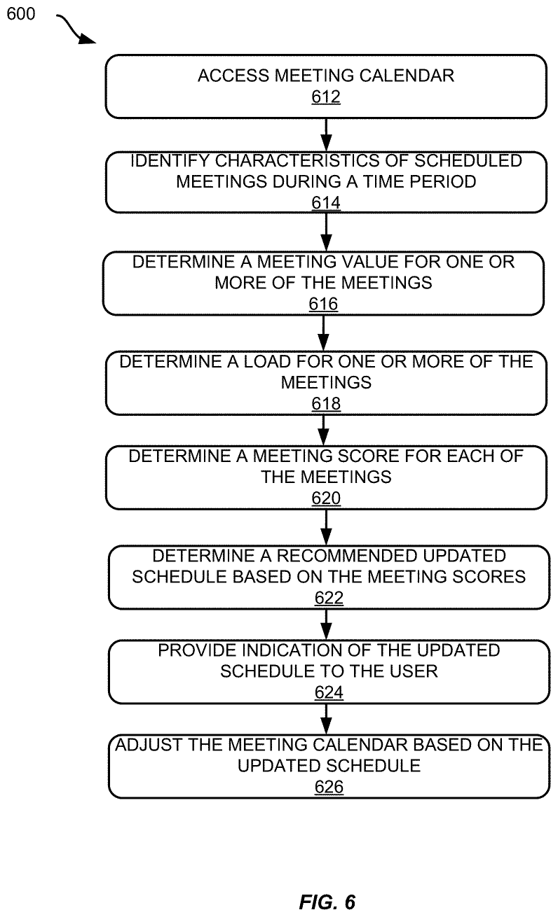

Referring now to FIG. 6, FIG. 6 shows an example method 600 for detecting user engagement and generating join recommendations. The example method will be discussed with respect to the systems shown in FIGS. 3 and 4; however any suitable system according to this disclosure may be employed.

At block 612, At block 612, the calendar analysis software component 400 executed by the video conference provider 310 accesses a meeting calendar associated with a user in the calendar information data store 422, generally as discussed above with respect to FIG. 4. In this example, the calendar analysis software component 400 accesses the meeting calendar in response to a request 410 received from a remote client device, e.g., client device 330a; however, in some examples, the calendar analysis software component 400 may access the meeting calendar automatically, such as at the end of a week preceding a time period to be analyzed.

At block 614, the calendar analysis software component 400 identifies one or more characteristics of scheduled meetings during a time period of the meeting calendar to be analyzed, generally as discussed above with respect to FIGS. 3 and 4. In some examples, and as discussed, the characteristics may include the dates and times of the respective meetings, the durations of the respective meetings, the user's roles in the respective meetings (e.g., host, organizer, presenter, participant, etc.), other attendees in the respective meetings, the roles of the other attendees, etc. In addition, the load determination and meeting value determination components 430, 440 may identify one or more characteristics associated with the scheduled meeting in the engagement information data store 424.

Further, as discussed above, characteristics of a scheduled meeting may be different for different users. While characteristics like the scheduled date, time, and duration may be common for all users, characteristics such as whether a user appears in a meeting agenda or not, whether a user is a “required” or “optional” attendee may vary by user, etc. Thus, for a scheduled meeting, the calendar analysis software component 400 may separately identify characteristics for each invitee to the meeting for which the method 600 is performed, which means that block 614 may be performed multiple times for a single scheduled meeting. However, in this example, the method 600 is performed for one user, thus block 614 is performed with respect to the user that issued the request 410.

At block 616, the calendar analysis software component 400 uses a meeting value determination component 440 to determine a meeting value for one or more of the scheduled meetings during the time period, generally as discussed above with respect to FIG. 4. In this example, the meeting value determination component 440 uses a trained ML model to determine the meeting values; however, other approaches as well. For example, a rules-based analysis may be employed, which may assign values to different meeting characteristics, e.g., one value if the user is the meeting host, a different value is the user is a meeting organizer or presenter, a further different value if the user is a participant, and another value if the user is an optional participant. Similarly, other characteristics may be assigned values. The values may then be weighted, in some examples, and combined, such as by summing or other operation or process. The meeting values may then be provided to the meeting analysis component 420.

At block 618, the load determination component 430 determines a meeting load for one or more meetings during the time period generally as discussed above with respect to FIG. 4. In this example, the load determination component 430 uses a trained ML model to determine the meeting load; however, other approaches as well, including a rules-based approach similar to the approach discussed above with respect to block 616. For example, different load values may be assessed for different meeting characteristics, which may be combined to determine a meeting load for a meeting. As discussed above, a meeting load may relate to a cognitive, physical, or other load imposed on the user. Thus, in some examples, the load determination component 430 may determine multiple different meeting loads for a particular meeting, each corresponding to a different type of load. The meeting load(s) may then be provided to the meeting analysis component 420.

At block 620, the meeting analysis component 420 generates a score for each meeting during the time period based on the respective identified characteristics, the respective meeting value, the respective meeting load(s), or a combination of some or all of such information, generally as discussed above with respect to FIG. 4. In this example, the meeting recommendation component 420 uses a trained ML model to generate the score based on the identified characteristics, the meeting value, and the meeting load(s); however, any suitable approach may be employed, such as a rules-based approach, similar to those discussed above with respect to blocks 616 and 618.

At block 622, the calendar recommendation component 450 determines a recommended updated schedule, generally as described above with respect to FIG. 4. As discussed above, the calendar recommendation component 450 may iteratively adjust the user's schedule during the time period and assess the impact on the user, such as by reducing meeting load while retaining meeting value and as many meetings as possible. The adjustments may include removing or rescheduling meetings with high loads but low value, changing manners of attending one or more meetings, e.g., by changing attendance from in-person to video or audio, etc. By making hypothetical adjustments to the user's calendar during the time period, the calendar analysis software component 400 can then assess the adjusted calendar and determine whether it improves on the user's actual calendar and, further, whether it improves on other potential adjustments to the user's calendar. The calendar recommendation component 450 may then provide one or more calendar recommendations to the notification component 460.

At block 624, the notification component 460 determines one or more notifications to provide and outputs one or more indications to cause the notification(s) to be provided to the participant, generally as described above with respect to FIG. 4. As discussed, the notification(s) may be visual notifications, such as changes in appearance to the user's electronic calendar, or textual notifications, such as messages indicating recommended changes to the user's schedule.

At block 626, the notification component 460 adjusts the meeting calendar based on the updated schedule, generally as discussed above with respect to FIG. 4. For example, the notification component 460 may decline or delete one or more meetings from the user's calendar. Similarly, it may request one or more meetings be rescheduled or propose a new date or time for a meeting to other attendees. Still other adjustments may be made according to some examples.

For example, in some examples, the notification component 460 may receive multiple recommended schedules from the calendar recommendation component 450. The notification component 460 may provide the user with an option to view and select one of the proposed recommendations. After receiving a selection from the user, the notification component 460 may then adjust the meeting calendar according to the received selection.

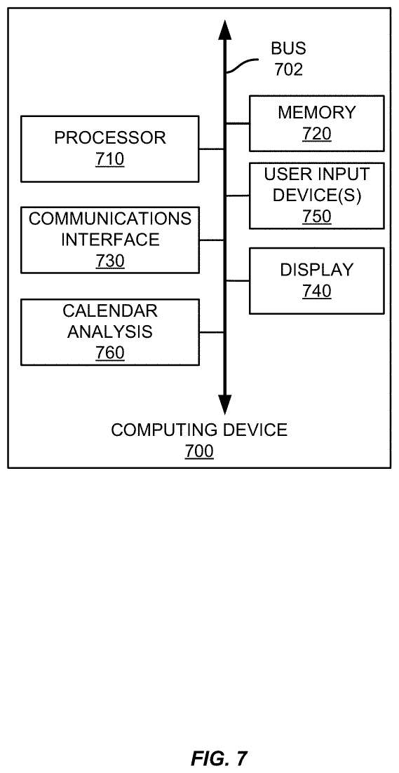

Referring now to FIG. 7, FIG. 7 shows an example computing device 700 suitable for detecting user engagement adjusting scheduled meetings. The example computing device 700 includes a processor 710 which is in communication with the memory 720 and other components of the computing device 700 using one or more communications buses 702. The processor 710 is configured to execute processor-executable instructions stored in the memory 720 to perform one or more methods for detecting user engagement adjusting scheduled meetings according to different examples, such as part or all of the example method 600 described above with respect to FIG. 6. The computing device, in this example, also includes one or more user input devices 750, such as a keyboard, mouse, touchscreen, microphone, etc., to accept user input. The computing device 700 also includes a display 740 to provide visual output to a user.

In some examples, the computing device 700 also includes a calendar analysis software component 760. Such functionality may be implemented according to various examples according to this disclosure, such as the example calendar analysis software component 400 shown in FIG. 4.

The computing device 700 also includes a communications interface 740. In some examples, the communications interface 730 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A method comprising:
accessing, by a calendar analysis software component executed by a video conference provider, a meeting calendar associated with a user;
determining, using a first machine learning (“ML”) model by the calendar analysis software component, meeting scores for a plurality of meetings scheduled during a time period in the meeting calendar;
generating, by the calendar analysis software component, a plurality of recommendations regarding adjusting a subset of the plurality of meetings in the meeting calendar; and
providing, by the calendar analysis software component, indications corresponding to the plurality of recommendations to the user.

2. The method of claim 1, further comprising adjusting, by the calendar analysis software component, the meeting calendar based on the plurality of recommendations.

3. The method of claim 1, wherein determining a meeting score for a first meeting of the plurality of meetings is based on one or more characteristics of one or more other meetings of the plurality of meetings.

4. The method of claim 3, further comprising:
determining, by a third ML model, a meeting value associated with one or more meetings of the plurality of meetings;
determining, by a fourth ML model, a load associated with the one or more meetings of the plurality of meetings;
wherein the first meeting is scheduled on a first day in the meeting calendar; and
wherein determining the meeting score for the first meeting is further based on the meeting values and loads of one or more other meetings of the plurality of meetings scheduled on the first day in the meeting calendar.

5. The method of claim 1, wherein one or more of the scheduled meetings are recurring meetings, and further comprising:
receiving historical engagement information associated with the user and past occurrences of the one or more recurring meeting; and
wherein determining a subset of the meeting scores for the scheduled meeting is further based on the respective historical engagement information.

6. The method of claim 1, further comprising:
determining, for one or more meetings of the plurality of meetings, a respective list of invitees; and
wherein determining the meeting scores for the one or more meetings is further based on the respective list of invitees.

7. The method of claim 1, wherein generating the plurality of recommendations comprises generating recommendations for the one or more meetings regarding whether to attend a respective meeting using audio only, a client device, reschedule the respective meeting, or not attend the respective meeting.

8. A system comprising:
a communications interface;
a non-transitory computer-readable medium; and
one or more processors communicatively coupled to the communications interface and the non-transitory computer-readable medium, the one or more processor configured to execute processor-executable instructions stored in the non-transitory computer-readable medium to:
access a meeting calendar associated with a user;
determine, using a first machine learning (“ML”) model, meeting scores for a plurality of meetings scheduled during a time period in the meeting calendar;
generate a plurality of recommendations regarding adjusting a subset of the plurality of meetings in the meeting calendar; and
providing indications corresponding to the plurality of recommendations to the user.

9. The system of claim 8, wherein the one or more processors are configured to execute further processor-executable instructions stored in the non-transitory computer-readable medium to adjust the meeting calendar based on the plurality of recommendations.

10. The system of claim 8, wherein determining a meeting score for a first meeting of the plurality of meetings is based on one or more characteristics of one or more other meetings of the plurality of meetings.

11. The system of claim 10, wherein the one or more processors are configured to execute further processor-executable instructions stored in the non-transitory computer-readable medium to:
determine, by a second ML model, a meeting value associated with one or more meetings of the plurality of meetings;
determine, by a third ML model, a load associated with the one or more meetings of the plurality of meetings;
wherein the first meeting is scheduled on a first day in the meeting calendar; and
wherein determining the meeting score for the first meeting is further based on the meeting values and loads of one or more other meetings of the plurality of meetings scheduled on the first day in the meeting calendar.

12. The system of claim 8, wherein one or more of the scheduled meetings are recurring meetings, and wherein the one or more processors are configured to execute further processor-executable instructions stored in the non-transitory computer-readable medium to:
receive historical engagement information associated with the user and past occurrences of the one or more recurring meeting; and
wherein determining a subset of the meeting scores for the scheduled meeting is further based on the respective historical engagement information.

13. The system of claim 8, wherein the one or more processors are configured to execute further processor-executable instructions stored in the non-transitory computer-readable medium to:
determine, for one or more meetings of the plurality of meetings, a respective list of invitees; and
wherein determining the meeting scores for the one or more meetings is further based on the respective list of invitees.

14. The system of claim 8, wherein the one or more processors are configured to execute further processor-executable instructions stored in the non-transitory computer-readable medium to generate recommendations for the one or more meetings regarding whether to attend a respective meeting by audio only, using a client device, reschedule the respective meeting or not attend the respective meeting.

15. A non-transitory computer-readable medium comprising processor-executable instructions stored in the non-transitory computer-readable medium to cause one or more processors to:
access a meeting calendar associated with a user;
determine, using a first machine learning (“ML”) model, meeting scores for a plurality of meetings scheduled during a time period in the meeting calendar;
generate a plurality of recommendations regarding adjusting a subset of the plurality of meetings in the meeting calendar; and
providing indications corresponding to the plurality of recommendations to the user.

16. The non-transitory computer-readable medium of claim 15, further comprising processor-executable instructions configured to cause one or more processors to adjust the meeting calendar based on the plurality of recommendations.

17. The non-transitory computer-readable medium of claim 15, wherein determining a meeting score for a first meeting of the plurality of meetings is based on one or more characteristics of one or more other meetings of the plurality of meetings.

18. The non-transitory computer-readable medium of claim 17, further comprising processor-executable instructions configured to cause one or more processors to:
determine, by a second ML model, a meeting value associated with one or more meetings of the plurality of meetings;
determine, by a third ML model, a load associated with the one or more meetings of the plurality of meetings;
wherein the first meeting is scheduled on a first day in the meeting calendar; and
wherein determining the meeting score for the first meeting is further based on the meeting values and loads of one or more other meetings of the plurality of meetings scheduled on the first day in the meeting calendar.

19. The non-transitory computer-readable medium of claim 15, wherein one or more of the scheduled meetings are recurring meetings, and further comprising processor-executable instructions configured to cause one or more processors to:
receive historical engagement information associated with the user and past occurrences of the one or more recurring meeting; and
wherein determining a subset of the meeting scores for the scheduled meeting is further based on the respective historical engagement information.

20. The non-transitory computer-readable medium of claim 15, further comprising processor-executable instructions configured to cause one or more processors to generate recommendations for the one or more meetings regarding whether to attend a respective meeting by audio only, using a client device, reschedule the respective meeting, or not attend the respective meeting.
